(19) United States
(12) Patent Application Publication
(10) Pub. No.: US 2026/0285473 A1
(43) Pub. Date: Sep. 24, 2026

(54) FLIGHT CONTROL SURFACE HAVING LITHIATED CARBON FIBERS STRUTS

(71) Applicants: Airbus Americas, Inc., MOBILE, AL (US); Airbus Operations GmbH, HAMBURG (DE)

(72) Inventors: Peter LINDE, HAMBURG (DE); Michael TELKAMP, HAMBURG (DE); Jeffrey NANGLE, MOBILE, AL (US)

(21) Appl. No.: 19/040,572

(22) Filed: Jan. 29, 2025

(51) Int. Cl. B64C 9/18; B64C 13/50; H02N 2/02

(52) U.S. Cl. CPC B64C 9/18; B64C 13/50; H02N 2/02

(57) ABSTRACT

A flight control surface for an aircraft. The flight control surface has a skin with an upper surface and lower surface and an internal cavity and, a strut within the internal cavity, the strut extending diagonally between the upper surface and the lower surface of the skin. The strut includes lithiated fibers which elongate in response to an electric current to change a camber of the flight control surface. Also a method for changing such a flight control surface and an aircraft with such a flight control surface.

### FIELD OF THE INVENTION

The invention relates to a flight control surface for an aircraft, and more particularly to a flight control surface that can change its camber with lithiated carbon fiber struts within the flight control surface.

### BACKGROUND OF THE INVENTION

In general, most aircraft require some aileron and/or rudder trim to achieve a straight and level flight. As would be understood by those of ordinary skill in the art, such control surface trim increases the aircraft fuel burn.

Accordingly, it would be desirable to provide a more effective and efficient way to provide for adjusting a flight control surface to reduce aircraft fuel burn associated with achieving a straight and level flight.

### SUMMARY OF THE INVENTION

An aspect of the present invention relates to a flight control surface that utilizes lithiated carbon fiber struts within the flight control surface to change a camber of the flight control surface upon application of an electric current to the lithiated carbon fiber struts. The modification of the camber could be used in any flight control surface, primary and secondary if applied for flaps or similar control surfaces, like flaperons. Additionally, the present invention may be used during flight for small lift management control without requiring flaps. This has the advantage of not causing noise in the aircraft cabin, as well as not requiring the need to move flaps into the fowler direction.

The term “lithiated” is to be understood as enriched or covered by lithium. A carbon fiber may be lithiated through electrodeposition of lithium ions, for example by immersing the fiber into a non-aqueous electrolyte, connecting a positive pole of a direct current source with the fiber to form an anode and a negative pole to a lithium containing electrode to form a cathode. Lithium ions will then move from the lithium source and attach to the anode. The carbon fibers may be lithiated prior to their deposition or they may also be lithiated afterwards. The lithiation enables the carbon fibers to release lithium ions.

Recently, it has been discovered that lithiated carbon fibers comprise piezoelectric properties. Consequently, if a lithiated fiber is subjected to a mechanical load due to a flexural deformation of the respective composite component, it will generate a certain electrical load, which can be measured against a reference potential. Thus, if an electrical load is applied to the respective lithiated fibers against a reference potential, the lithiated fibers are subjected to a flexural deformation. As a lithiated carbon fiber is based on a common carbon fiber, the carbon fiber provides the required reinforcement.

Additional advantages include providing reliable and simple means of trimming control surfaces without mechanically movable actuators.

The trim control with the lithiated carbon fiber struts mainly affects the camber, and in this manner, skew surface settings that consume fuel may not be needed or required.

The trim control may take place with small amounts of electrical energy.

Upon lithiation, the struts will maintain an increased length until another electrical current is applied.

Furthermore, as noted above, there may be no need to move the flaps in the fowler direction and thus, no need to create noise associated with same in the aircraft cabin.

Accordingly, a first aspect of the present invention is a flight control surface for an aircraft. The flight control surface comprises a skin having an upper surface and lower surface and forming an internal cavity, and, a strut within the internal cavity, the strut extending diagonally between the upper surface and the lower surface of the skin. The strut comprises lithiated carbon fibers configured to elongate in response to an electric current and change a camber of the flight control surface.

Optionally, the strut comprises a hollow rod. Further optionally, the hollow rod may comprise a first layer comprising carbon fibers with an electrode active material coating to form a positive electrode, a second layer comprising the lithiated carbon fibers embedded into a matrix to form a negative electrode, and a separator layer electrically isolating the first layer and second layer from each other. The separator layer may comprise a glass fiber reinforced plastics material or the separator layer may comprise carbon fibers having an electrically isolating coating. Optionally, the electrode active material coating comprises LiFePO₄.

Optionally, the flight control surface further comprises a rotating connection element at each end of the strut.

Optionally, the flight control surface further comprises a plurality of spars extending between the upper surface and the lower surface. Further optionally, each spar of the plurality of spars may comprises an upper flange and a lower flange. The spars from the plurality of spars may comprise a carbon fiber reinforced plastic (CFRP). Optionally, the skin of the flight control surface comprises a carbon fiber reinforced plastic (CFRP).

Optionally, the flight control surface further comprises a plurality of struts within the internal cavity, the struts from the plurality of struts extending diagonally between the upper surface and the lower surface of the skin, the struts from the plurality of struts comprising lithiated carbon fibers configured to elongate in response to an electric current and change a camber of the flight control surface. Each strut from the plurality of struts may extend between two spars from the plurality of spars.

A second aspect of the present invention is an aircraft comprising a flight control surface according to the first aspect.

A third aspect of the present invention is a process for changing a camber of a flight control surface, the flight control surface having a skin with an upper surface and lower surface and forming an internal cavity, and, a strut within the internal cavity, the strut extending diagonally between the upper surface and the lower surface of the skin, the strut comprising lithiated carbon fibers. The process comprises applying an electric current to the strut so that the strut elongates and changes the camber of the flight control surface.

Additional aspects, embodiments, and details of the invention, all of which may be combinable in any manner, are set forth in the following detailed description of the invention.

### BRIEF DESCRIPTION OF THE DRAWINGS

Embodiments of the invention are described in more detail with reference to the accompanying schematic drawings that are listed below:

FIG. 1 depicts an aircraft according to one or more aspects of the present disclosure;

FIG. 2 depicts a schematic, side view of a prior art flap;

FIG. 3 depicts a schematic, side view of a flap according to one or more aspects of the present disclosure;

FIG. 4 depicts a schematic, side view of a flap according to one or more aspects of the present disclosure with an electric current applied showing a change in a chamber of the flap;

FIG. 5 depicts a cross section of a strut according to one or more aspects of the present disclosure taken from line A-A in FIG. 3; and,

FIG. 6 depicts a layered arrangement of materials that may be used to form a strut according to one or more aspects of the present disclosure.

In general, the same reference numbers will be used throughout the drawing(s) and accompanying written description to refer to the same or like parts. Additionally, all reference numbers may not be included in a drawing for clarity purposes.

### DETAILED DESCRIPTION OF THE PREFERRED EMBODIMENTS

As mentioned above, with lithiated carbon fibers, a control surface can have its camber changed with the application of an electrical current.

With these general principles in mind, one or more embodiments of the present invention will be described with the understanding that the following description is not intended to be limiting.

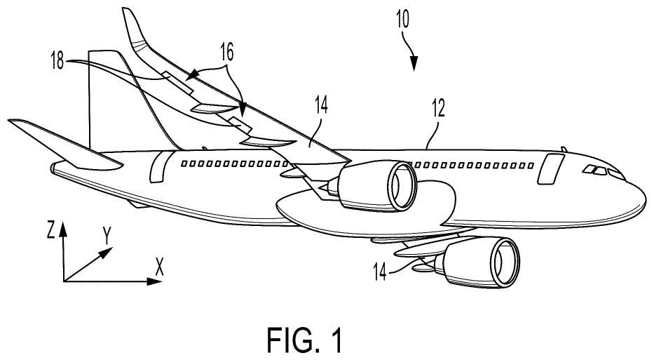

Referring to FIG. 1, an aircraft 10 has a fuselage 12 and a pair of wings 14 attached to the fuselage 12. By convention, X denotes a longitudinal axis of the aircraft 10, this axis X being parallel to a longitudinal direction of the aircraft. Moreover, Y denotes a transverse axis of the aircraft 10, this axis being horizontal when the aircraft 10 is on the ground, and Z denotes a vertical axis or vertical height when the aircraft 10 is on the ground, these three axes X, Y, and Z being mutually orthogonal. Moreover, directional terms, such as “front” and “rear” or “upper” and “lower”, are to be considered relative to a direction of forward movement of the aircraft 10 in the depicted orientation.

Each of the wings 14 includes one or more flight control surfaces 16 which in this case may be flaps 18. However, the present invention may be utilized with other flight control surfaces 16 including, alerions, spoilers, wings, vertical stabilizers, horizontal stabilizers, and others.

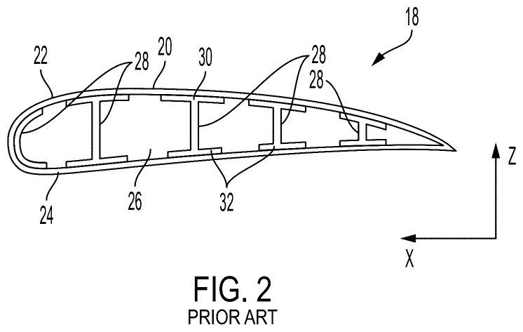

Turning to FIG. 2, the flap 18 includes a skin 20 having an upper surface 22 and lower surface 24 and forming an internal cavity 26. The skin 20 may be formed from a carbon fiber reinforced plastic (CFRP) material. As is known the CFRP material includes carbon fibers embedded into a matrix material, such as heat curable resin or a thermoplastics material. Other materials may be used provided they have sufficient flexibility to be stretched.

Within the internal cavity 26, one or more spars 28 extend between the upper surface 22 and the lower surface 24. The spars 28 each have an upper flange 30 and lower flange 32 which may be used to attach the spars 28 to the skin 20. The spars 28 may also be formed from a CFRP material.

The depicted flap 18 is a multi spar flap which has more than two spars 28 within the internal cavity 26. This is merely exemplary and not intended to be limiting.

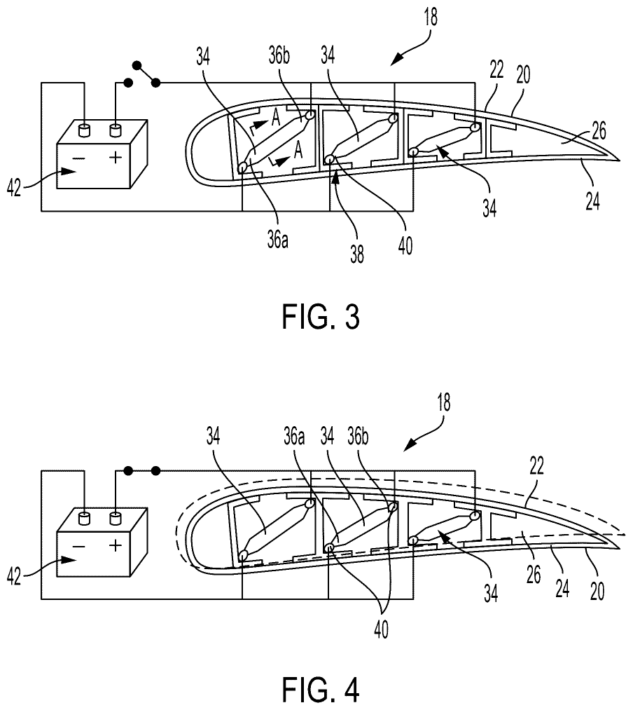

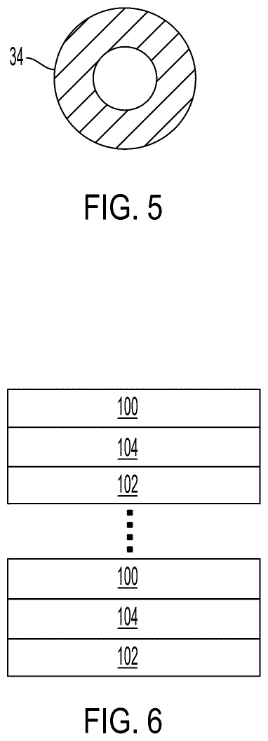

Turning to FIGS. 3 and 4, according to the present invention, the flap 18 (or other flight control surface 16) includes at least one strut 34 within the internal cavity 26. The strut 34 extends diagonally between the upper surface 22 and the lower surface 24 of the skin 20. The strut 34 may be a hollow rod or have a portion with a hollow rod shape. See, FIG. 5. Ends 36a, 36b of the strut 34 may be fixed to one of the spars 28. Preferably, each end 36a, 36b of a strut 34 is secured to a different spar 28. Preferably, the ends 36a, 36b of the strut 34 include a rotating connection element 38 such as a spherical bearing 40 which will preclude any secondary bending movement.

The strut 34 is formed from a material such that it includes lithiated carbon fibers which will elongate in response to an electric current and change the camber of the flap 18 (or other flight control surface 16).

Accordingly, as shown in FIG. 6 the strut 34 may include a first layer 100 with carbon fibers with an electrode active material coating which forms a positive electrode. The electrode active material coating may be LiFePO₄ or LiCoO₂, to name a few. The strut 34 may include a second layer 102 including the lithiated carbon fibers embedded into a matrix to form a negative electrode. A separator layer 104, electrically isolating the first layer 100 and the second layer 102 from each other, is provided as well. Together, the first and second layer 100,102 provide a type of piezo actuator. Any number of pairs of first and second layers 100, 102 may be provided.

Returning to FIGS. 3 and 4, with the struts 34 having lithiated carbon fibers in the second layer 102, as a result of an electrical voltage applied from an electrical source 42, a length of the strut 34 increases, which will exert a force on the flap 18 (or other flight control surface 16) and change its camber. See FIG. 4.

The separator layer 104 is provided for electrically isolating consecutive layers, such that a short circuit may be avoided when applying the voltage. The separator layer 104 may be a glass fiber reinforced plastics material. Thus, the separator layer 104 may be sufficiently permeable for the lithium ions and may further contribute to the stiffness of the strut. Still further, with glass fiber reinforced plastics material, the manufacturing method for the strut 34 does not necessarily need to be unnecessarily modified, since the glass fiber reinforced plastics material may be handled and processed in the same way as carbon fiber reinforced plastics material of the other layers 100, 102. Additionally, and/or alternatively, the separator layer 104 may include carbon fibers having an electrically isolating coating. Hence, the separator layer 104 may have the same stiffness as the other layers 100, 102 made from a carbon fiber reinforced plastics material.

When the voltage is applied to the respective layers 100, 102, lithium ions will travel between the first layer 100 and second layer 102. Thus, the separator layer 104 also needs to be permeable for lithium ions. The combination of the first layer 100, the second layer 102, and the separator layer 104 resemble a battery-like structure. The combination of a plurality of these structures parallel to each other lead to a piezoelectric actuation arrangement having a high maximum force. By providing a selective application of the voltage to only one pair of first and second layers 100, 102 or a subset of pairs of layers 100, 102, the achievable force may be modulated as desired.

Accordingly, a process for changing a camber of a flight control surface 16 may include providing a flight control surface 16 having a skin 20 with an upper surface 22 and lower surface 24 and forming an internal cavity 26. The flight control surface 16 includes one or more struts within the internal cavity 26. Additionally, each strut 34 is formed from a material that includes lithiated carbon fibers.

The process includes applying an electric current to at least one strut 34 so that the strut 34 elongates and changes the camber of the flight control surface 16. If the strut 34 is made of multiple pairs of layers 100, 102, the electric current may be applied to all or some of the pairs to achieve a desired camber. Additionally, and/or alternatively, if there are plurality of struts 34 provided, the electric current may be applied to all or some of the struts 34 to achieve a desired camber. Accordingly, by selectively applying an electric current, a desired camber may be obtained for the flight control surface 16. The desired camber may provide a flight control surface 16 that requires less fuel consumption compared with conventional adjustments to flight control surfaces.

After having the camber changed, another electrical current may be applied to reduce a length of the elongated struts 34 so that the flight control surface 16 returns to its original camber. One of ordinary skill in the art will appreciate that an intermediate camber may be achieved by selective application of the second electrical current to less than all of the elongated struts 34, or less than all of the pairs of layers 100, 102 forming the elongated struts 34.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

It is to be noted that the term “or” as used herein is to be interpreted to mean “and/or”, unless expressly stated otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A flight control surface for an aircraft, the flight control surface comprising:
a skin having an upper surface and lower surface and forming an internal cavity; and,
a strut within the internal cavity, the strut extending diagonally between the upper surface and the lower surface of the skin, the strut comprising lithiated carbon fibers configured to elongate in response to an electric current and change a camber of the flight control surface.

2. The flight control surface of claim 1, wherein the strut comprises a hollow rod.

3. The flight control surface of claim 2, wherein the hollow rod comprises a first layer comprising carbon fibers with an electrode active material coating to form a positive electrode, a second layer comprising the lithiated carbon fibers embedded into a matrix to form a negative electrode, and a separator layer electrically isolating the first layer and second layer from each other.

4. The flight control surface of claim 3, wherein the separator layer comprises a glass fiber reinforced plastics material.

5. The flight control surface of claim 3, wherein the separator layer comprises carbon fibers having an electrically isolating coating.

6. The flight control surface of claim 3, wherein the electrode active material coating comprises LiFePO₄.

7. The flight control surface of claim 1, further comprising:
a rotating connection element at each end of the strut.

8. The flight control surface of claim 1, further comprising:
a plurality of spars extending between the upper surface and the lower surface.

9. The flight control surface of claim 8, wherein each spar of the plurality of spars comprises an upper flange and a lower flange.

10. The flight control surface of claim 8, wherein the spars from the plurality of spars comprise a carbon fiber reinforced plastic (CFRP).

11. The flight control surface of claim 10, wherein the skin comprises a carbon fiber reinforced plastic (CFRP).

12. The flight control surface of claim 8, further comprising:
a plurality of struts within the internal cavity, the struts from the plurality of struts extending diagonally between the upper surface and the lower surface of the skin, the struts from the plurality of struts comprising lithiated carbon fibers configured to elongate in response to an electric current and change a camber of the flight control surface.

13. The flight control surface of claim 12, wherein each strut from the plurality of struts extends between two spars from the plurality of spars.

14. An aircraft comprising:
the flight control surface of claim 1.

15. A process for changing a camber of a flight control surface, the flight control surface having a skin with an upper surface and lower surface and forming an internal cavity, and, a strut within the internal cavity, the strut extending diagonally between the upper surface and the lower surface of the skin, the strut comprising lithiated carbon fibers, the process comprising:
applying an electric current to the strut so that the strut elongates and changes the camber of the flight control surface.
